(19) United States
(12) Patent Application Publication
(10) Pub. No.: US 2010/0175136 A1
(43) Pub. Date: Jul. 8, 2010

(54) SYSTEM AND METHOD FOR SECURITY OF SENSITIVE INFORMATION THROUGH A NETWORK CONNECTION

(76) Inventors: Moran Frumer, Ramat Hakovesh (IL); Lior Frumer, Ramat Hakovesh (IL)

Correspondence Address: DR. D. GRAESER LTD., 9003 FLORIN WAY, UPPER MARLBORO, MD, 20772, US

(21) Appl. No.: 12/602,161

(22) PCT Filed: May 29, 2008
(86) PCT No.: PCT/IL08/00733

§ 371 Date: Nov. 30, 2009

Related U.S. Application Data
(60) Provisional application No. 60/924,759, filed on May 30, 2007.

(51) Int. Cl. G06F 7/04

(52) U.S. Cl. 726/26

(57) ABSTRACT

A system and method for preventing phishing attacks by comparing the address of a Web site to which a user wishes to enter sensitive information (or indeed any type of user information) to at least one previous address to which the user already submitted at least a portion of this information. If the current address and the previous address are not identical, the user is preferably at least alerted; more preferably transmission of the information is blocked. The present invention may also optionally operate even if only a portion of the sensitive information is submitted, such as only the password for example.

### FIELD OF THE INVENTION

The present invention relates to a system and a method for security of sensitive information through a network connection, and in particular, to such a system and method which block fraudulent attempts to obtain the information of a user through the network connection.

### BACKGROUND OF THE INVENTION

The Internet has enabled computer users all over the world to interact and communicate electronically. One particularly popular mode for communication is through Web pages, which collectively form the World Wide Web. Web pages are useful for displaying text and graphics, and even animation, video data and audio data. Unsurprisingly, Web pages have also become popular for interactions which involve sensitive information, such as bank accounts, credit card transactions and the like. However, many users have had their sensitive information stolen from them, often leading to severe monetary losses, through the fraudulent transmission of messages purporting to have been sent from a recognized institution or provider with which the user has an account and/or otherwise interacts based upon sensitive information. The message typically contains a link to a web site and a request for the user to enter sensitive user information at the web site, such as a username and password. Such fraudulent transmission is known as “phishing”. In cases in which a specific user is targeted by name, it is known as “spear phishing”.

Upon receiving such a message, the user, believing it to have been sent from the recognized institution or provider, opens a link to a Web page as directed and enters a login name and password. The stolen information is then used to illegally obtain money (for example from a user's bank account) and/or to otherwise illegally obtain a financial or other advantage. Various solutions have been proposed in an attempt to block such illegal activity and the concomitant financial losses which arise. For example, U.S. patent application No. 2006/0174119 describes a method for storing the sensitive information of the user; however, the user must select the data to protect as the method does not operate automatically. Also the user sensitive data can be retrieved from the repository where it is stored, as it is not masked or blocked. The method also cannot handle complex web forms or sophisticated forms of fraud.

Other proposed solutions focus upon the link contained in the e-mail, comparing such links to a list of known or suspected phishing web sites; such solutions are provided by most known web browsers and toolbars nowadays. U.S. patent application No. 2005/0289148 describes a method for identifying suspected patterns in an email message that may indicate that the email is a spoof or phishing email, followed by warning the user about it. Access to the site is blocked or the user is warned that the web site is dangerous. Links may be analyzed when contained in an e-mail message or upon a request of the user to access a web site associated with the link. Although this method does not involve remote storage of or access to the user's sensitive information, it is clearly less effective because it relies upon a list of web sites and/or analysis of a domain name, which cannot always detect “phishing” web sites.

U.S. patent application No. 2006/0068755 describes a method for pro-actively identifying suspicious web site domains; once these domains become active, a warning may be sent to users attempting to access the web site. Again, although this method does not involve remote storage of or access to the user's sensitive information, it is clearly less effective because it relies upon a list of web sites and/or analysis of a domain name, which cannot always detect “phishing” web sites.

U.S. patent application No. 2006/0224511 describes a method for analyzing the login behavior of a plurality of users to a computer system, such as that of a bank for example, for fraudulent behavior. This method attempts to detect such fraudulent behavior at the system of the bank or other organization and to block access to the system once it is apparent that “phishing” messages have been received by users of the system. However, the sensitive user information can still be easily obtained through fraudulent phishing messages; the above method does not attempt to protect the user from such fraud.

A better solution would protect users from providing their sensitive information to fraudulent locations on-line, such as fraudulent web sites, without requiring such information to be stored in a clearly readable or accessible format and without requiring the user to actively select information to be protected. Unfortunately such a solution is not available.

### SUMMARY OF THE INVENTION

There is an unmet need for, and it would be highly useful to have, a system and a method for blocking fraudulent provision of the sensitive information of a user to a web site. There is also an unmet need for, and it would be highly useful to have, a system and a method for blocking such activity without storing the sensitive information on a third party system and/or in a clear, readable or accessible format, and also without requiring the web site address (URL) to match a known fraudulent location.

The present invention overcomes these drawbacks of the background art by providing a system and method in which the address of a Web site to which a user wishes to enter sensitive information (or indeed any type of user information) is compared to at least one previous address to which the user already submitted at least a portion of this information. If the current address and the previous address are not identical, the user is preferably at least alerted; more preferably transmission of the information is blocked. Should the user choose to send the information, then this choice is preferably noted and the data is also preferably associated with the current address. Optionally, the data may be associated with the current address and with the previous address, or alternatively only with the current address or the previous address. If the data has not previously been submitted to an address (and hence is not associated with an address), then preferably it is stored with the address as a new data/address pair.

Address within the context of the present invention refers to an network address available on the internet or an intranet used to identify or locate a computer or server within a network. For example an address may interchangeably refer to a Universal Resource Locator also known as URL and used interchangeable herewith, Internet Protocol address also known as “IP” and used interchangeable herewith description or website address in the form of “www.websitename.com”, or other domain names.

Address pair or information pair within the context of the present invention is referred to as any pair of data most preferably including a URL or address, forming a first member of the pair, and user authentication data, user sensitive data, forming a second member of the pair, that are linked in a database. Preferably, user authentication data or sensitive data may optionally comprise at least two or more individual data entries. Most preferably address pair is encrypted using one way encryption protocol.

White List within the context of the present invention refers to a database containing domains that are considered by the List owners to be trusted sites that do not undertake identity fraud. Common use of white list is a notification icon in user browser, notifying the user of the status of the site with regard to the white list. Optionally, all addresses or sites having a valid authenticated security certificate as a white list site. Optionally, the white list will include most financial sites, big email services or the like having taken sufficient security measures. Most white list site information is accessible by the user's browser and therefore preferably readily accessible by the application.

By “online”, it is meant that communication is performed through an electronic communication medium, including but not limited to, telephone voice communication through the PSTN (public switched telephone network), cellular telephones or a combination thereof; exchanging information through Web pages according to HTTP (HyperText Transfer Protocol) or any other protocol for communication with and through mark-up language documents; exchanging messages through e-mail (electronic mail), messaging services such as ICQ™ for example, and any other type of messaging service; any type of communication using a computational device as previously defined; as well as any other type of communication which incorporates an electronic medium for transmission.

According to preferred embodiments of the present invention, the system and method of the present invention operate automatically to protect the data of the user, and not only upon user's request. Also optionally and preferably, the present invention is not operative only upon the occurrence of a submit event, and indeed may preferably detect phishing attempts that do not necessarily include an identified submit event (for example by detecting a time to submit parameter as described in greater below).

A method according to an optional embodiment of the present invention for preventing fraudulent provision of a user's sensitive data to a network address through a markup language interface comprising:

associating a user' s sensitive data with a network address forming an information pair;

storing the information pair on computer readable media;

monitoring an entry wherein the sensitive data is to be submitted through a markup language interface to a network address;

if the sensitive data matches the information pair but the network address does not match the information pair, determining whether an action is to be taken.

Optionally, the method further comprises registering the entry wherein at least one of the user's sensitive data is submitted to the network address through a network connection.

Optionally, the method further comprises alerting the user. Optionally, alerting the user further comprises at least one or more or a combination of requesting user permission to continue submission, blocking the submission, requesting user permission to add the network address for submission to a permitted white list.

Optionally, if the user approves submission the system and method according to the present invention stores the network address and the sensitive information as an information pair.

Optionally, the method according to an optional embodiment further comprising blocking the submission. Optionally, any blocked submissions to a network location are added to a black list.

Optionally, the network address and the sensitive information are stored as an information pair. Optionally, storing the information pair may optionally be a user mediated process or an automated process. Optionally user permission comprises requesting user permission to store the information pair, such that the information pair is stored only with the user permission. Optionally, storing the information pair is performed automatically, without user intervention. Optionally, automatic storing of the information pair further comprises filtering the sensitive data before the storing.

According to an optional embodiment of the method of the present invention user sensitive data is stored in an encrypted format. Optionally, encrypted user data is stored on computer readable media for example including but not limited to a local computer, a computer and/or any peripheral device or other electronic device of the user. Optionally, the encrypted format is created according to one-way encryption, or the like encryption as is known and accepted in the art.

Optionally, the markup language interface optionally includes but is not limited to .a web browser, web page, web forms, chat room, instant message and an email client or the like markup language user interface or markup language platform.

Optionally the user sensitive information optionally includes but is not limited to username, password, identification number, passport number, driver's license, social security number, security code, insurance policy number, security question and security answer, biometric parameters or the like.

An optional embodiment of the present invention provides for encrypted remote data storage. Preferably, remote data is accessible through a network connection, for example including an internet or intranet connection or the like. Optionally, access to the network connection requires user authentication for example including but not limited to username, password, biometric parameters or the like means for user authentication as is known and accepted in the art.

Optionally the information pair may be formed automatically by a computer or manually by a user. Optionally, an automatically formed information pair may be formed by reference to historical user data. Optionally, the sensitive data of the information pair optionally comprises at least one or a plurality of data items. Optionally, at least one or more data items pass through at least one or more filters. Optionally, filter relates to a structure of the data item.

Optionally, monitoring the entry optionally comprises determining whether suspicious activity is occurring at the mark-up language interface. Suspicious activity optionally includes but is not limited to operating a script by the mark-up language interface and submitting data character by character.

A method according to an optional embodiment of the present invention for preventing fraudulent provision of a user's sensitive data to a network address through a markup language interface comprising:

Associating a user's sensitive data with an approved network address forming an information pair;

storing the information pair on computer readable media;

monitoring entries wherein the sensitive data is submitted through a markup language interface;

monitoring an entry wherein the sensitive data is to be submitted through a markup language interface to a network address;

if the sensitive data matches the information pair but the network address does not match the information, temporarily preventing transmission of the sensitive data to the network address.

Optionally, the method further comprising: comparing the network address to a white list preferably comprising a plurality of pre-approved permissible network address;

If the network address is found, permitting the transmission.

Optionally, the method further comprising: alerting the user when the white list comparison fails. Optionally, the white list may be formed automatically by a computer or manually by a user.

An optional embodiment according to the present invention for a system for preventing fraudulent provision of a user's sensitive data to a network address through a markup language interface comprising: antifraud software able to identifying fraudulent network address by utilizing a data repository of information pairs, each pair comprising sensitive user data and a network address. Optionally, the data repository may be located locally or remotely. Optionally a remote data repository may be connected to antifraud software through a network connection for example including an internet or intranet, or the like as is known and accepted in the art. Optionally, the data repository is locale and available on a local computer. Optionally, the data repository comprises at least one or a plurality of users. Optionally, a local data repository may optionally comprise a plurality of user defined repositories. Optionally, a remote repository may optionally comprise a plurality of user defined repositories. Optionally, access to a remote repository is mediated by user authentication means for example including but not limited to username, password, biometric parameters and captcha or the like as is known and accepted in the art.

A method according to an optional embodiment of the present invention for preventing fraudulent provision of a user's sensitive data to a network address through a markup language interface comprising:

Associating a user's sensitive data with a pre-approved network address forming an information pair;

storing the information pair on computer readable media;

and wherein the markup language interface supports an email interface;

and wherein a markup language link is activated from an email message received through the email interface;

monitoring entries wherein the sensitive data is submitted to a network address through a markup language interface associated with the markup language link;

registering the entry wherein at least one of the user's sensitive data is submitted to the network address through a network connection;

monitoring a threshold of the registered entries;

comparing the threshold of registered entries to the information pair;

identifying instances wherein the comparison fails;

preventing transmission of the threshold registered entries to the network address; and

alerting the user when the comparison fails.

A method according to an optional embodiment of the present invention for preventing fraudulent provision of a user's sensitive data through a chat interface comprising:

storing a user's sensitive data;

monitoring entries wherein the sensitive data is submitted through the chat;

alerting the user before the sensitive data is submitted.

A method according to an optional embodiment of the present invention for preventing fraudulent provision of a user's sensitive data to a network address through a markup language interface comprising:

Associating a user's sensitive data with a network address forming an information pair;

storing the information pair on computer readable media;

monitoring an entry wherein the sensitive data is to be submitted through a markup language interface to a network address;

if the sensitive data matches the information pair but the network address does not match the information, detecting potential fraud. Optionally, the method further comprising: preventing submission of the entry pending user instructions.

Optionally any of the optional embodiments of the present invention for the prevention of fraudulent provision of a user's sensitive data to a network address may optionally be limited by at least one or more controllable parameter. For example, a controllable parameter optionally including but not limited to number of addresses protected, access time, number of attempts to access and the markup language interface or the like.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A-B are descriptions of an exemplary method according to the present invention;

FIG. 1C is a description of an exemplary method according to the present invention further utilizing a pre-approved white list of non-phishing sites; and

FIG. 2A-B are schematic block diagrams of exemplary system according to the present invention.

FIG. 3 is a flowchart of an exemplary method according to the present invention for phishing protection through a centralized repository available to a plurality of users.

FIG. 4 is a description of an exemplary method according to the present invention for phishing protection during a messaging application.

FIG. 5 is a description of an exemplary method according to the present invention for phishing protection from embedded links.

FIG. 6 depicts a further example of an implementation and use of a central repository with a plurality of users.

### DESCRIPTION OF THE PREFERRED EMBODIMENTS

The present invention is of a system and a method for preventing the user from submitting user information, such as personal information and/or sensitive information and the like, to a web site which fraudulently appears to be related to a legitimate organization and/or web site to which the user normally submits this information. A non-limiting example is for the user to mistakenly submit the username and password to a web site which seems to be related to the user's bank, but which in fact is a phishing (fraudulent) web site.

According to a preferable embodiment the system and method operate by comparing the address of a Web site to which a user wishes to enter sensitive information, for example including but not limited to username, password, identification number, passport number, driver's license, social security number, security code, insurance policy number, security question, security answer or the like user information, to at least one previous address to which the user already submitted at least a portion of this sensitive information. If the current address and the previous address are not identical, the user is preferably at least alerted; more preferably transmission of the information is blocked; optionally transmission is blocked temporarily. The present invention may also optionally operate even if only a portion of the sensitive information is submitted, such as only the password for example.

The principles and operation of the present invention may be better understood with reference to the drawings and the accompanying description.

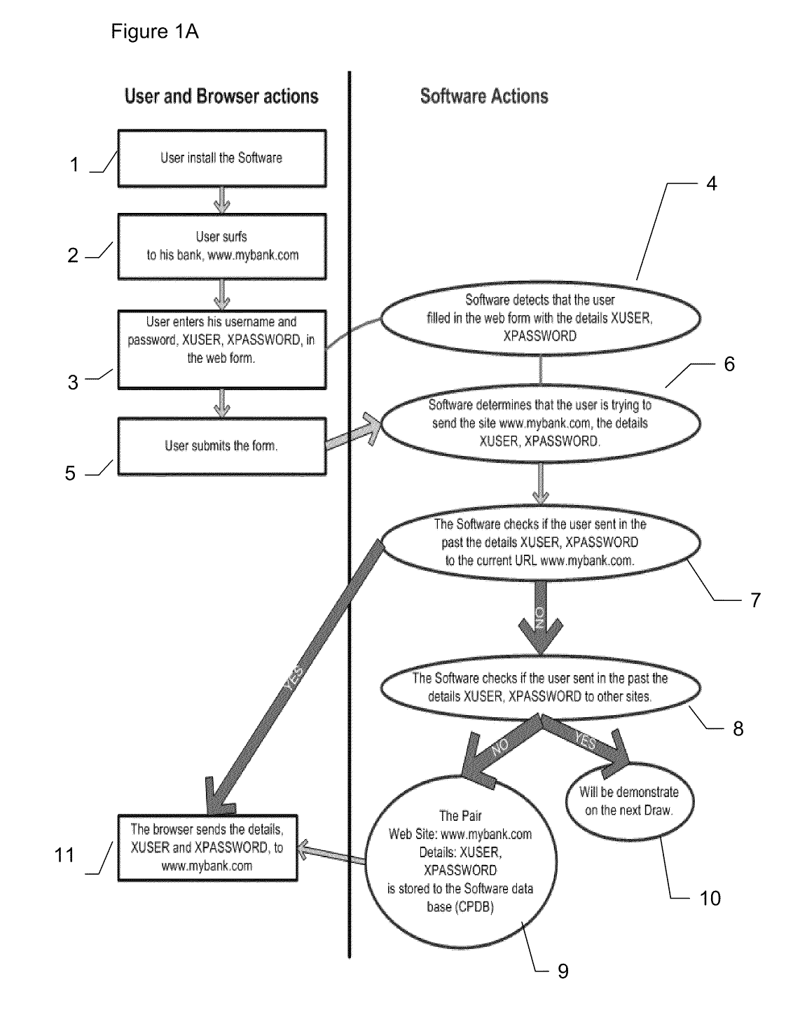

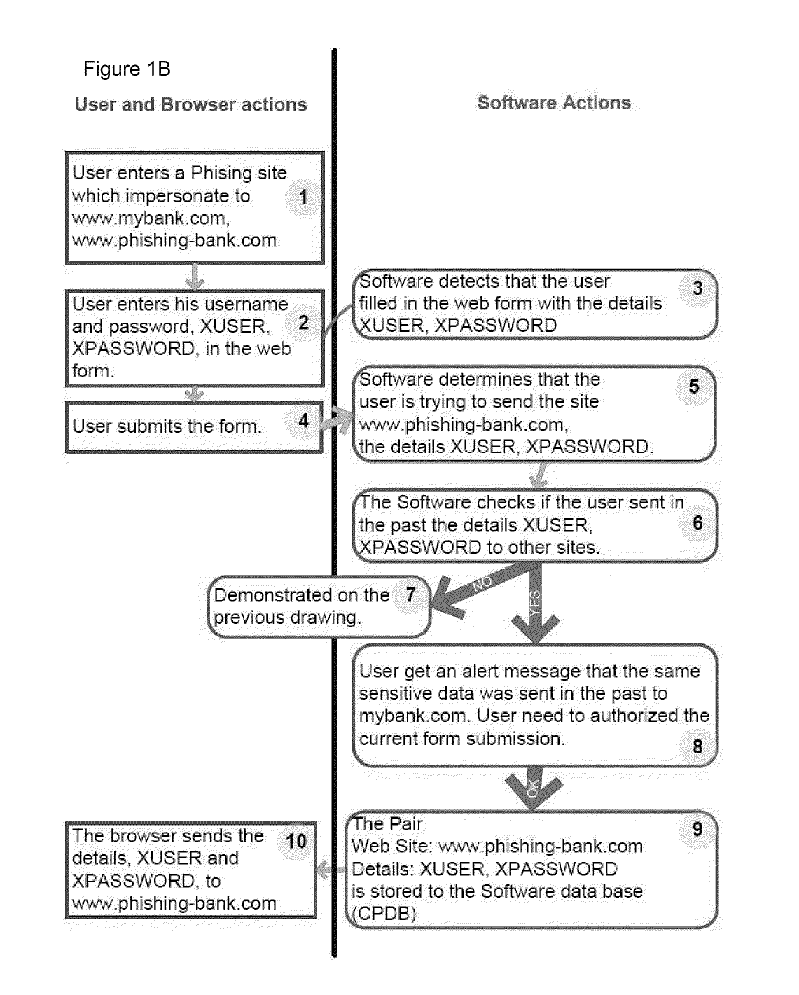

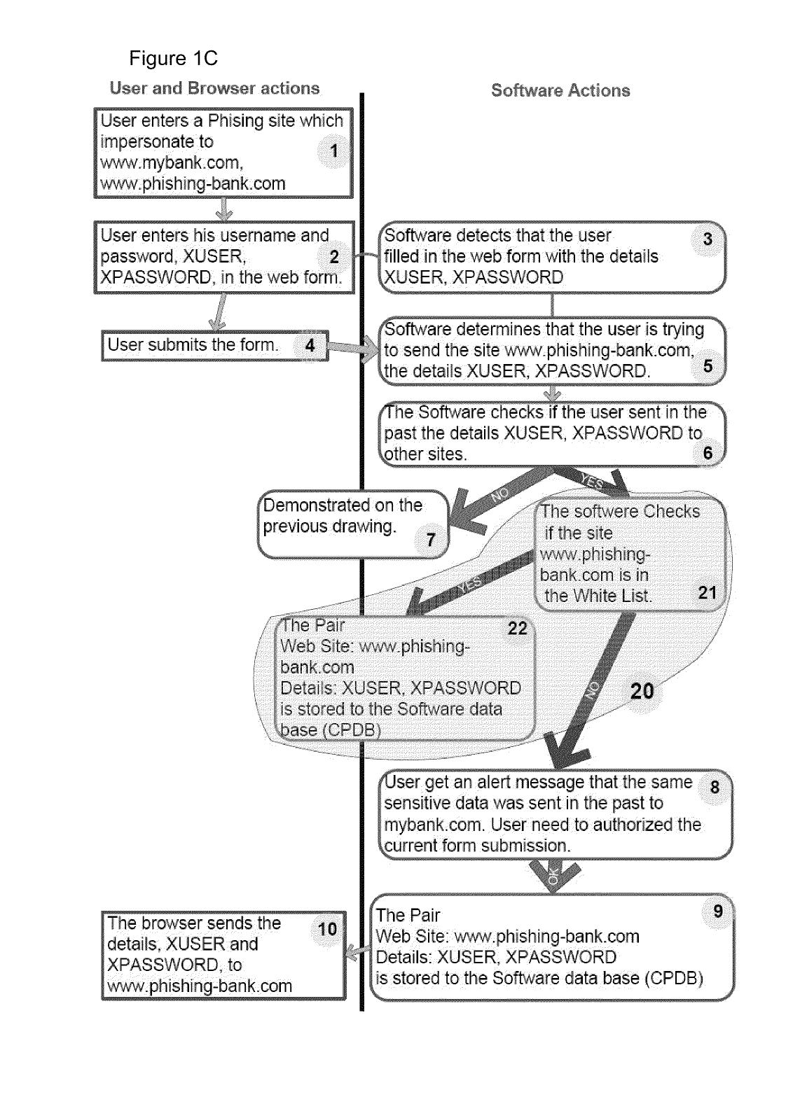

Referring now to the drawings, FIG. 1 is a description of an exemplary method according to the present invention. FIG. 1A provides a description of the method during an attempt to provide information to a legitimate web site; FIG. 1B provides a description of the method during an attempt to provide information to a non-legitimate or “phishing” web site. For both figures, the actions of the user and/or web browser are shown on the left hand side, while those of the software according to the present invention are shown on the right hand side.

In FIG. 1A, the user first preferably installs software according to the present invention on the user's computer (stage 1). Optionally a portion of the “logic” or code may be stored outside of the computer, optionally and preferably on a separate and/or peripheral device, for example including but not limited to a USB Key, or the like. The software may optionally be installed as stand-alone software and/or as a “plug in” or other adjunct software to a Web browser, such as the Internet Explorer® software (Microsoft Corp, Washington, USA).

In stage 2, the user opens a web site for example the user's bank, shown as “www.mybank.com” for the sake of illustration only. Such a web site may optionally be entered or opened in any way, for example by being manually typed or otherwise entered by the user, and/or by being selected from a “favorites” list or other previously prepared list of web sites and/or by being selected from a history list or other list of previously accessed web sites and/or through a “link” or “clicking on” or otherwise selecting a hyperlink which points to the web site, for example with a mouse or other pointing device.

In stage 3, the user enters the required user authentication data or sensitive information for example including but not limited to username and password (shown in FIG. 1A as “XUSER” and “XPASSWORD” respectively) to the bank web site, “www.mybank.com” in order to login. Optionally any other type of login information may be provided in addition to, or in place of, the username and password, for example including social security number, identification number or the like.

In stage 4, the software according to a preferred embodiment of the present invention detects that the user has entered the details of the username and password to the web form on the web page.

In stage 5, the user submits the web form, for example by “clicking on” or otherwise selecting a GUI gadget marked for this purpose and/or by pressing the “enter” key on the keyboard or any other method for causing the sensitive information to be submitted to the web site.

In stage 6, the software determines that the user has submitted and/or is attempting to submit the information to the web site. In stage 7, the software compares the details entered (XUSER, XPASSWORD) to the address or URL of the web site. If the address of the web site matches a previously used address for the entered details, then the software permits the submission to occur (see stage 11 below).

If the web address does not match the previously used address, the software determines whether the entered details were submitted to a different address or URL of the web site (stage 8).

If the entered details have never been previously submitted to a web site, then in stage 9, the information pair of the web address and the entered details is preferably stored for future comparison. More preferably at least the entered details are encrypted or otherwise secured as described in greater detail below. Such encryption is optionally and more preferably one-way encryption, also as described in greater detail below.

Also more preferably, the stored information pair is stored on the computer of the user and/or a peripheral device or other device which is capable of communicating with the computer of the user, also as described in greater detail below. Optionally, the user is alerted to the fact that the entered details were not previously submitted to a web site, so that the user may optionally choose to block such a submission and/or to consider whether the web site is legitimate before permitting the details to be submitted, although such an alert is optionally and alternatively not performed.

If the details were previously submitted to a different web page, then a similar process is performed in stage 10 as described with regard to FIG. 1B.

In either case, once the software has determined that the entered details may be sent to the web site, the software permits the web browser of the user's computer to submit the information in stage 11.

FIG. 1B provides a description of the exemplary method according to the present invention during an attempt to provide information to a non-legitimate or “phishing” web site once the previously described software has been installed and the user logged in to the legitimate web site at least once, as described in 1A, which in this non-limiting example is the web site of a bank.

As shown in FIG. 1B, in stage 1 the user opens a web site purporting to be from the user's bank but which is in fact a “phishing” web site, described as “www.phishingbank.com” for the purpose of illustration only. In stage 2, the user enters the details of “XUSER” and “XPASSWORD” as previously described in FIG. 1A, as the user is unaware of the fact that the current address is a “phishing” web site. In stage 3, the software again detects entry of these details. In stage 4, the user attempts to submit the web form to the “phishing” address. In stage 5, the software determines that the user is trying to submit the information to the “phishing” web site. In stage 6, the software compares the details entered (XUSER, XPASSWORD) to the address or URL of the “phishing” web site. If the details, for example including but not limited to a username, password and address, were not previously entered, as shown in stage 7, then the method according to a preferred embodiment of the present invention operates as described for FIG. 1A.

In stage 8, if the details were previously entered, then a comparison of the details determines that the address of the “phishing” web site does not match that of the legitimate previously used web site. If the address does not exactly match an address for which the details are stored, and the details were previously entered for another web site, then the software preferably at least warns the user about the potential for fraud, as shown by the exemplary displayed alert, but optionally blocks the transmission in any case. Optionally and preferably the displayed alert provides the user with at least one and more preferably a plurality of options depicting the following optional actions to be taken, for example including but not limited to continuing or canceling the transmission of the personal information to the address in question. If the user is warned as shown, the user may provide further instructions optionally by pressing or selecting “cancel” to stop the transmission. Alternatively, the user may choose to submit the data as shown by pressing or selecting “ok” as shown, in which case optionally and preferably a new information pair of the web address and the entered details is stored. If the user chooses to send the information, the user may also optionally add the site to the personal white list as described later; this personal white list preferably includes acceptable addresses for which no alert is then preferably issued.

Optionally, if the user decides to cancel the transmission, preferably not only is the information not sent to the web site but optionally further actions are also taken, such as sending the phishing site information to one or more central systems or databases to alert other users and so on.

In stage 9, the information pair of the (presumably legitimate and not fraudulent) web site and the entered details is optionally and preferably stored as described in FIG. 1A. In stage 10, the user name and password are sent to the requested web site. This situation could arise legitimately if the user has the same username and password for more than one site (for example if the user has multiple Internet or on-line bank accounts with the same user name and password).

As shown, the present invention preferably operates without sending any information to any third party system and without reviewing or accessing any previously determined lists of suspected or known fraudulent web addresses, or indeed any other external data. Preferably the analysis is based largely if not entirely on the prior behavior/actions of the user on the user's computer, although the above functionality could optionally be added to the present invention if desired.

The present invention also does not require analysis or detection of any characteristics of web sites/URLs in order to determine if they are safe or suspected. It tracks and monitors the data sent by the user to web sites and alerts whenever the user is trying to submit set of details to a web site for the first time and/or when the user attempts to submit such details to a web address which is different from a previously used address.

According to other optional but preferred embodiments of the present invention, the information pair may optionally and preferably comprise both entered details as “raw” details as well as “sent” details. The raw details are those typed or otherwise entered by the user, for example through the web browser's auto complete feature or drop down boxes. The sent details are the details sent over the web. The raw data can be optionally manipulated and/or altered by scripts included in the web page and/or the web browser and/or a plug-in or other add-on to the web browser. For example, a JavaScript in the web page code and/or the web browser and/or plug-in or other add-on may optionally add one or more extraneous characters to the raw details for security purposes. On the other hand, a phishing web site may attempt to somehow modify the entered details before transmission in order to block detection of transmission of the details.

FIG. 1C provides a flowchart of an optional, exemplary embodiment of a method according to the present invention, wherein an external database is used to determine safety of a site as depicted in optional intermediate stages 20 that may optionally take place in the transition from stage 6 to stage 8 as depicted in FIG. 1B. Both FIG. 1B and 1C comprise the same labels and numbering scheme to reflect the same stage and method used in both. Most preferably, stage 20 comprising stage 21 and 22 is performed using a White List database, according to an optional embodiment of the present invention comprising data relating to address and sites that are deemed to be safe or secure sites that do not promote or use fraudulent data. In stage 21 the system and method according to the present invention determines if the site being accessed is in the white list; if it is not than the system progresses to stage 8 producing an warning and alter as described in FIG. 1B. If the address is on the white list then preferably and optionally, the system goes to stage 22 as a warning is not warranted adding the site data and information pair in the repository according to the present invention. Optionally, the white list data is gathered based on data obtained from a plurality of databases, a single database or a locally run program or code that confirms the site's security measures rendering it safe for use or the like source for evaluating the security level and requirements of a site.

According to other preferred embodiments, the software of the present invention is also able to detect one or more actions of the web browser, for example detecting execution of one or more scripts and/or ActiveX controls (or other types of code). If such one or more actions by the web browser has not previously occurred during a previous submission of the entered details, the software may optionally and preferably block the submission and/or at least alert the user, even if the web address appears to match the raw (and optionally also sent) details.

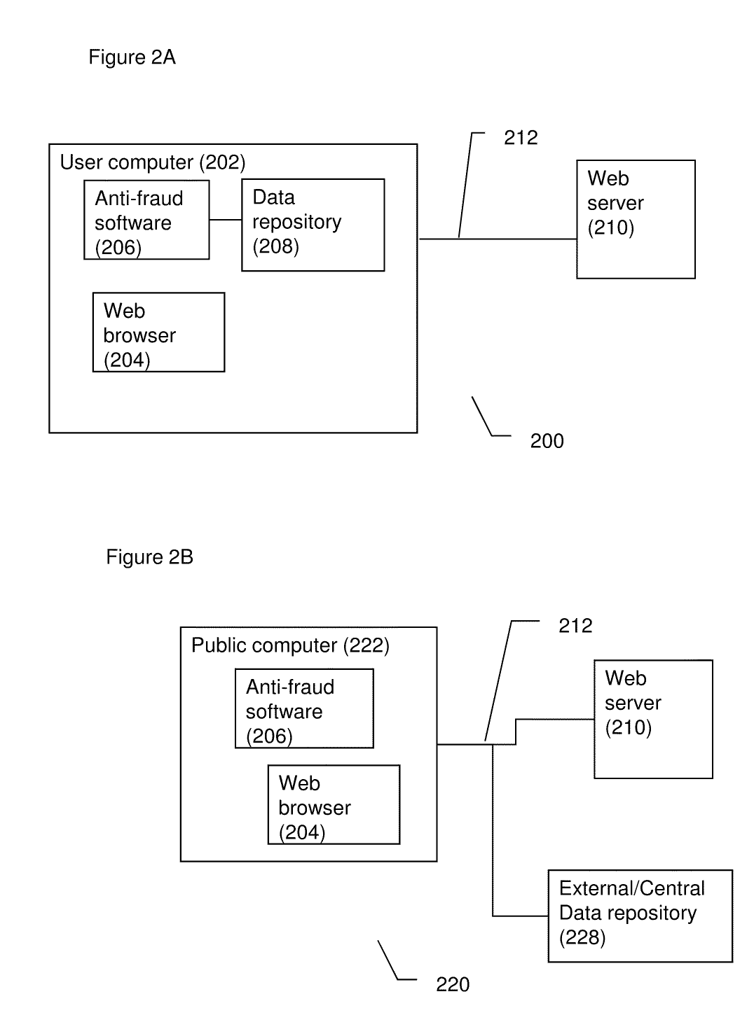

FIG. 2A is a schematic block diagram of an exemplary system according to the present invention. As shown, a system 200 features a user computer 202 for operation by a user (not shown). User computer 202 preferably features a web browser 204 for displaying information, such as web pages, according to HTTP (HyperText Transfer Protocol) or any other protocol for communication with and through mark-up language documents. It should be noted that the operation of system 200 is described with regard to a web browser for the purpose of description only and without any intention of being limiting.

User computer 202 also preferably features an anti-fraud software module 206 for analyzing data entered for submission through web browser 204, or more specifically through a web page (and/or a web form) displayed by web browser 204. Anti-fraud software module 206 preferably analyzes information pairs as previously described, each of which features one or more entered details and a web address to which the information is to be submitted. These information pairs are stored in a data repository 208, which may optionally be located on user computer 202 as shown, or alternatively and optionally may be located on a peripheral device and/or other device separate from user computer 202, including but not limited to a “disk on key” or other USB storage device, a diskette or a CD-ROM, or a cellular telephone or other external device, which is capable of communication with user computer 202. Data repository 208 may also optionally reside on a remote or local server (not shown see FIG. 2B).

User computer 202 is preferably in communication with a web server 210 through a network 212, which is optionally the Internet, although network 212 could optionally comprise any type of computer network. User computer 202 could itself comprise any type of computational device as described herein.

Web server 210 sends mark-up language information, such as according to HTTP as previously described, to web browser 204. This information causes web browser 204 to display a web page (not shown), including a request for the user (not shown) to enter one or more pieces of sensitive information (details), such as for example a username and a password. The user enters such information to the web page, for example through a web form. Anti-fraud software module 206 preferably monitors the actions of web browser 204 in order to prevent the entered information from being immediately sent to web server 210, for example character by character as previously described. Alternatively, if information is submitted character by character it may optionally be tracked by anti-fraud software module 206, for example in order to warn the user should the user later wish to cancel the transaction before “sending” or submitting it.

Once the user causes the entered information to be submitted, anti-fraud software module 206 detects the entered information, for example by detecting a “submit event” for a web browser page as is known in the art. Alternatively or additionally, any web request generated by the user may optionally be considered to be a submit event. As a non-limiting example, a user may press a button (GUI gadget) that looks like a “submit” button but is actually a hyper-link to another fraudulent web page. This fraudulent hyper-link may approve the previous submission of information character by character as previously described with regard to the example of such thefts being performed through execution of an Ajax script.

In addition, anti-fraud software module 206 detects the address of the web page to which the information is being submitted. Preferably anti-fraud software module 206 detects the IP address of the domain name for the web site being hosted by web server 210, although alternatively or additionally anti-fraud software module 206 detects the domain name only and/or a combination thereof. It should be noted that some types of fraudulent software and/or scripts attempt to redirect data submission to a location other than that indicated by the domain name/IP address for the web site; this behavior is also preferably detected by anti-fraud software module 206. For example some phishing techniques feature changing the textual URL being displayed in the address bar. The anti-fraud software of the present invention detects the exact web source of the form page and the exact destination of the submitted data (ie the exact IP addresses of the form page and of the destination), ignoring any diversions used by the fraudulent sites.

According to preferred embodiments of the present invention, the web address is detected as follows. Optionally, anti-fraud software module 206 detects and stores the exact URL but alternatively may optionally store a “core” URL and ignore any additional or random characters. For example, web server 210 may optionally use changing parameters in the login URL, such that the URL for “mybank.com” may look like “mybank.com/login?random=ver43w3” for a first viewing and “mybank.com/login?random=vr545y45” for a second viewing and so forth, for a different URL each time but with the same “core” URL of “mybank.com/login”. Anti-fraud software module 206 may optionally prompt the user each time that the different URL appears; alternatively anti-fraud software module 206 may determine whether the same IP address is involved as the same “core” URL is present, although the URL is different. The user may also optionally be prompted to approve submission of the entered details to the same domain name even if the “core” URL is the same but the exact URL is different (for example by parsing the URL to extract the domain name for the “core” URL). The “core” URL may optionally only include a name, such as MyBank.com for example, with different word(s) on either or both sides of this name (server.MyBank.com, MyBank.com/server and so forth).

Anti-fraud software module 206 may optionally scan the history (previously viewed web pages) of web browser 204 in order to analyze and store web pages with changing URLs to data repository 208. For example, anti-fraud software module 206 may locate 20 occurrences of the web page “mybank.com/login” in the history of web browser 204 with 20 different random values. Anti-fraud software module 206 may optionally store in data repository 208 the instruction to ignore the random parameter on the login web page for the domain MYBANK.COM.

For secure login pages (such as those provided through HTTPS or, preferably, login web pages with valid security certificate(s) from one or more organizations) which were accessed by typing the URL manually and/or accessed through a “favorites” list, any query parameter is optionally ignored by anti-fraud software module 206, at least for alerts, preferably upon instruction by the user. Optionally however, anti-fraud software module 206 is able to save any sensitive data entered, but without an alert being produced upon submission of such data.

Turning back now to the entered information, anti-fraud software module 206 preferably converts the entered information to an encrypted format and/or some other format. More preferably the conversion is provided through one-way encryption, such that the actual entered information cannot be accessed from the encrypted data. The entered and converted information is then compared to the converted information stored in data repository 208. If the converted information is not found in data repository 208, then anti-fraud software module 206 may optionally alert the user as previously described (although such an alert is not required); if authorized by the user (or if no alert is given), the converted entered information is preferably stored as part of an information pair with the web address in data repository 208.

If the converted information is found in data repository 208, then anti-fraud software module 206 preferably compares the web address stored as part of the information pair to the actual web address to which web browser 204 as previously described. If the two match, then anti-fraud software module 206 permits web browser 204 to send the entered details to web server 210. If they do not match, then anti-fraud software module 206 preferably at least alerts the user, for example by displaying a warning window (not shown), such that the user must indicate that the data is to be sent; alternatively, anti-fraud software module 206 may block submission of the data.

According to preferred embodiments of the present invention, other information and/or additional information may optionally be stored in data repository 208 for comparison to information entered or provided at a later time. As a non-limiting example of such information, a parent form may optionally be stored. This form is the last web page (or other type of mark-up language document) to which the user has entered the personal data under consideration; information stored may optionally include the number of pages viewed in between and the time elapsed between views.

As a non-limiting example, a web site may request User ID on one page; after submission of this data, the user is requested to type the password on the next page. Anti-fraud software module 206 preferably recognizes the sequence of two different web pages for submitting two types of information, such that a set of two user entered fields was submitted to a certain web site in two separate web pages. This sequence is then preferably stored in data repository 208 as being related to the information pair. Should the personal information (entered details) be entered in a different sequence or manner, optionally regardless of the web page address, anti-fraud software module 206 preferably alerts the user (and/or blocks transmission of the data). Another type of optionally stored information is the submit time and type, which is the amount of time required or elapsed from entry of the personal data until the submit action, and the submit action type. For example, suppose that a phishing web page sends the entered user information to the server as it is typed, letter by letter (or character by character), for example by utilizing a local AJAX application. Such a sight although it will display a web browser button that looks like the submit data button may actually be a non functioning graphic icon and therefore user information may be fraudulently obtained, even if the user does not perceive as having provided it by clicking on the submit button or enter buttons. An optional embodiment of the present invention preferably provides protection against such phishing attempts as appropriate user parameters associated with a site may used to determined user behavior in order to protect the user. For example, such parameters may including submit time allowed or normally used by the user.

Saving the submit time and type allows the software algorithm to create time thresholds for each set of user details and to activate the user alert system if the time threshold passes without any submit action. For example, if the user usually submits “USER”,“PASSWORD” to the site MYBANK.COM and presses the submit data button in less than 3 seconds from the last typing, but then the user types “USER”,“PASSWORD” to the site PHISHING-BANK.COM but no submit action follows the typing, the software preferably issues a phishing alert, based on the time threshold, after 5 seconds.

An optional embodiment of the present invention provides for a system that learns and analyzes the login process associated with a particular site, for example including but not limited to the time thresholds between entries, the number of pages used, the time difference between pages, the number of entries required, the time difference required between each field entry, the type of data required, or the like and producing an alert when the form and login process does not follow that expected, stored or analyzed by the system and method of the present invention.

Yet another example of optionally stored information is user information usage statistics related to the frequency of usage. For example, the web site MYBANK.COM may optionally require a text verification field for each login. After several logins, anti-fraud software module 206 may determine that the text verification field is random and may optionally prompt the user to approve it so anti-fraud software module 206 can ignore this field for any real or phishing login attempt.

A further example of an optional method for protecting user sensitive information by verifying the intended destination of the sensitive information at various stages of its entry may be incorporated into the system and method of the present invention to prevent AJAX theft as a non-limiting example of “character by character” theft. Preferably, any form of character by character theft may be prevented for example AJAX theft, as described above, or similar technologies and methods that are based on reading user submitted data character by character on a page. For example, the User enters the username in the proper field and later moved to a different field, while moving to the next field, the system according to an optional embodiment compares the user name and site, if the username belong to a different site and was never saved for the currently loaded site, an optional embodiment preferably recognizes this as a potential phishing attempt. Optionally, in response the system and method may optionally respond by at least temporarily eliminating all AJAX and/or other scripting activity on the page, until further verifications provide the reinstatement of AJAX and/or other scripting activity. Further verification optionally includes but is not limited to user response to an alert, a white list check, a black list check, an external security check or the like.

Another example of optionally stored information is field type, such that for example, a string of user information that is a password is marked as a “password type”. This field type is indicated in the HTML code and hence is simple to detect.

A non-limiting use of the above described detection of field type is to block an attack, particularly a “spear phishing” attack (in which the name/identity of the user is know), through a web site which only requires the user to enter his/her password. Anti-fraud software module 206 preferably alerts the user that a frequently or at least previously used password is being entered to a new site. For example, if anti-fraud software module 206 determines that “XPASSWORD” is the password in a set of details sent at least once if not frequently to mybank.com, along with the user name, but the password is then entered by the user as the only piece of data to a web site which is not mybank.com, anti-fraud software module 206 preferably alerts the user. Moreover, anti-fraud software module 206 may optionally and preferably compare strings from the web page to check if any of them matches “XUSER” (the regular user name associated with “XPASSWORD”) which increases the likelihood that the user is being attacked with a phishing attempt.

Anti-fraud software module 206 may also optionally issue an alert related to sending events, if the web browser sent any user information to web server 210 prior to the submit action, for example through Ajax. For example, continuing the above example, suppose that PHISHING-BANK.COM did use Ajax in order to obtain the user information before submission Anti-fraud software module 206 may inform the user that the personal details were stolen already and may also suggest to the user to change the typed data to fool the attackers as described herein.

Another example of analyzed information is whether the web address was entered as a typed URL or alternatively was accessed through a web page hyper link. If the user manually types the URL, then it is less likely to be related to a phishing site; however any type of hyper link access could potentially be related to a phishing site. For example, if a user accesses a map web site frequently, either manually or from the “favorites” list, and then enters a password or other information, anti-fraud software module 206 preferably does not issue an alert.

Anti-fraud software module 206 preferably encrypts the data to be stored in data repository 208, more preferably through one way encryption, optionally using any well known algorithm such as MD5 for example. One way encryption does not permit decryption of the data to the original data, such that no method can be used to access the user information. However, the stored encrypted data can be compared to newly entered data by first encrypting the newly entered data, which is preferably performed by anti-fraud software module 206. Once encrypted with the same one-way algorithm, the newly entered data may be compared to the previously stored data in data repository 208, to determine whether it is identical. The stored data therefore may be considered to be a type of “digital summary” or identifier, which is sufficient to determine whether the newly entered data is identical to previously entered data while still preventing access to the actual data itself.

For example, suppose that the user submits the password “XXX” to the legitimate web site of the user's bank for the first time. The value that is stored in data repository 208, after encryption by the one-way encryption method as performed by anti-fraud software module 206, may be “99AD7AA75AF6” for example. Each time that the same password “XXX” is entered by the user, anti-fraud software module 206 encrypts the password and obtains the same value “99AD7AA75AF6”. Thus, the resultant value may optionally and preferably be compared for the newly entered information to previously stored information, even though the password itself is not stored, nor is its actual value accessible.

According to preferred embodiments of the present invention, even submission of partial information preferably triggers an anti-phishing alert if submitted to a different web address. For example, a password alert may optionally be implemented if the user is requested by web page for which the web address is not stored in the data repository to type only the password. The present invention recognizes the string as being stored in the repository and preferably provides a password alert, indicating to the user that the password that was previously submitted to a particular web site is now being submitted to a new website.

According to other preferred embodiments of the present invention, the present invention may optionally be combined with one or more other types of anti-phishing systems, such that the software may optionally be combined and/or run in parallel with any other such system.

For example, the present invention may optionally retrieve data from black list databases, such that for each web address of a web page, the present invention checks the web address against a black list of known or suspected fraudulent sites.

The present invention could also optionally or additionally retrieve data from white list databases, which are lists of sites that are known to be authorized non Phishing sites. This operation could be helpful if the user uses the same username and password at more than one legitimate website.

The present invention may also optionally contribute information to black and white list databases, based on user decisions upon receiving software alerts.

According to an optional embodiment of the present invention, a user may create, edit, or use a personalized white list. For example, a personalized white list would be used to reduce the number of alters rendered for sites that a user trusts or continuously deems trustworthy. For example, if a User tries to login to his email service provider page using his bank account user authentication details by mistake, the system generates an alert which may be avoided if the user chooses to add the email account to the user defined personal white list, preventing future triggers of the alert associated with that site and wrong user sensitive information.

According to other preferred embodiments, the present invention may optionally receive specific information from legitimate web sites in order to improve and/or streamline operation, for better security and fewer interruptions for the user. As a non-limiting example, if a particular data string needs to be entered, the software of the present invention could optionally be adjusted to expect such a string. For example suppose that one bank (or other organization) provides the data that the user name (required for login) is always a 10 digit sequence that starts with 0 and the sum of the first 4 digits is 45; furthermore login requires a password of 6-8 characters with at least one capital and at least one digit. An embodiment of the software algorithm according to the present invention may optionally then have a lower threshold to block and/or alert the user whenever such criteria match user data which is being sent to a different website. Any such adjustment could assist the user by resulting in reduced interruptions. Regarding better security, a website could for example optionally inform the software of the present invention that two separate web pages are required for login as described above.

According to still other preferred embodiments, the present invention may optionally and preferably be implemented in a specialized version for a particular service provider. For example, a bank could optionally customize the present invention to be specially operative with the URL and other web site configuration information of the bank, such as the location and order of information fields on one or more web pages which could be provided in advance. This customization could optionally be performed for any service provider. The present invention could also optionally be customized for an Internet Service Provider (ISP), Wi-Fi provider or indeed any provider of computer network connectivity, as well as for intra-nets (internal computer networks for organizations such as corporations for example).

FIG. 2B is a schematic block diagram of an optional system according to an optional embodiment of the present invention depicting an implementation in which information on a public computer is protected from phishing attempts, rather than a personal computer as depicted in FIG. 2A above. By “public computer” it is meant any computer being accessed by or at least accessible to a plurality of users. Similar labeling and numbering is used as in FIG. 2A above for the same or similar functioning components.

As shown, system 220 features a user (not shown) using a public computer 222 providing access for a plurality of users. Preferably, public computer 222 comprises anti-fraud software 206 and Web browser 204 as depicted in FIG. 2A above. Public computer is preferably connected to a central/external data repository 228 via a network connection 212 for example including but not limited to an internet or intranet connection. Central/External data repository 228 functions in the same manner as data repository 208 described earlier to store sensitive information most preferably in a secure manner, for example including but not limited to encryption, one way encryption or the like.

As previously described, Anti-fraud software module 206 preferably analyzes information pairs, each of which features one or more entered details and a web address to which the information is to be submitted. These information pairs are stored in external/central data repository 228 most preferably comprising information pairs for a plurality of users. Preferably central repository 228 provides secure access to individual personal information pairs independently of individual users, and most preferably allows a plurality of computer to connect simultaneously through network 212. Network connection 212 preferably facilitates and provides the means for communication between at least one or more public computer 222, external data repository 228 and at least one or more Web server 210 as described in FIG. 2A so as to provide protection to a user (not shown) against phishing attempts when using a public computer 222.

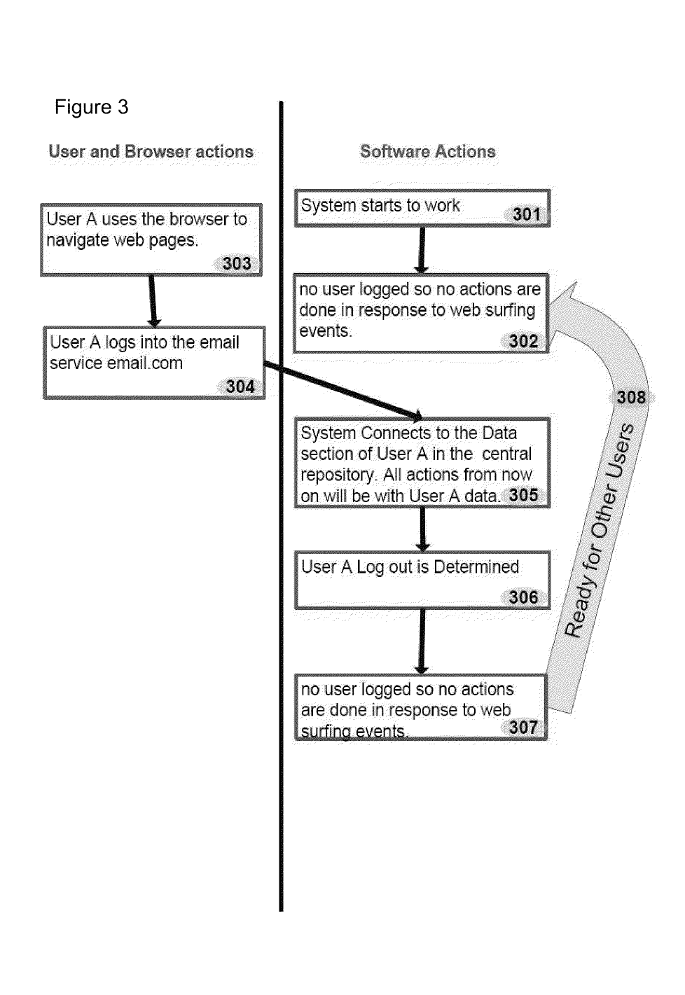

For example, public computer 222 may be used to access web based information such as bank details, check email accounts or the like web based activity when a personal computer 202 is not available such as when traveling. Public computer 222 may be more prone to phishing attempts as the security level offered may be reduced. An optional embodiment of the present invention as depicted in FIG. 3 shows an exemplary method of how a central repository according to an optional embodiment of the present invention may be implemented using public computer 222 within system 220 of FIG. 2B to preferably protect a user against phishing attempts according to an optional embodiment of the present invention while utilizing external data repository 228 as a central data repository.

Stages 301 and 302 are a non limiting example of use of the central repository on a public computer 222 that is ready for use and waiting for a user to log on, according to an optional embodiment of the present invention. Optionally any computer, PDA, mobile telephone or the like comprising a network connection providing active access to an email account may be used to access the central repository according to an optional embodiment of the present invention. In stage 303, User A logs onto the public computer 222 preferably using browser 204 to navigate to a web based email account available on web server 210.

In stage 304 User A provides web browser 204 personal information required to access User A′s email account, for example including but not limited to username, password, biometric markers or the like types of user authentication as is known and accepted in the art. Preferably, logging into User A's email account in stage 304 automatically activates User A's access to his central repository account according to an optional embodiment of the system and method of the present invention. Most preferably, as long as User A is logged into the email account, as in stage 305, User A is most preferably protected against phishing attempts through use of the central repository according to an optional embodiment of the present invention, as described earlier as depicted in FIG. 1A-B. In stage 305, preferably Anti-Fraud software 206 connects to data repository 228 through network connection 212 to access repository data specific to User A. Most preferably, any Web sites or that are accessed by User A through connection 212 while logged into his email account are channeled through data repository 228 to protect User A from phishing attempts. Preferably, once User A logs off his email account in stage 306 he preferably simultaneously disconnects data repository 228 from public computer 222 therein preferably resetting the connection in stages 307 and 308, while data repository 228 awaits access by a new user from public computer 222.

An optional embodiment according to the present invention further comprises a filter for the stored repository data, that optionally and preferably controls the number of alerts triggered by the system and method of the present invention. Optionally, for example, the number of alerts may have a ceiling (whether as an absolute number, rate per time period (minute, hour, day, week, month etc) or maximum allowed number per number of user activities, etc) in order to reduce interruptions to user activities and/or to prevent abuse of the system. Therefore, the number of alerts is preferably balanced with the need to protect the user while also reducing interruptions to user activities, as an excessive number of interruptions may cause the user to disable the installed software for implementing the system or method of the present invention, for example.

Also if the software has a limit to the number of sites (domains/URLs for example) being protected, then it may operate more efficiently. For example, if mybank.com is not in the protected list, then the software will not save this site login information and will not issue an alert based on this data; for example, the alert described in stage 8 of FIG. 1B will not occur as mybank.com is not in the protected list. The system may optionally have a fixed list of sites it is protecting and no other sites. Such a number may also optionally be determined by customization of the software according to the present invention, as described in greater detail below.

Optionally, the system and method of the present invention may determine (and/or allow the user to select) which of the sensitive personal information is to be stored in the repository to maximize performance of the system and again optionally and preferably to reduce the number of alerts. Optionally, the system may choose to incorporate or save at least one or more fields or forms for example including but not limited to, forms having masked password fields, field types that don't have spaces, and so forth. Optionally the system and method of the present invention may utilize a controllable number of additional text fields for example including but not limited to address, zip code, company name or the like that may optionally be used to authenticate user personal data. Most preferably the number of additional text fields used is such that security is not compromised while minimizing the number of alerts, such that a maximum number of fields for retaining user details is determined in order to prevent unnecessary alerts. For example, many registration forms use more than four (for example) data fields with frequently requested data, such as zip codes, etc that form information comprised within an address pair; in such cases the total number of fields with relevant user data may optionally be restricted to be four fields or any other suitable number. Optionally, phishing alerts according to a preferred embodiment of the present invention will not occur if the number of sensitive data entries submitted to a network address surpasses a controllable floor threshold of user sensitive data entries, for example 4 individual user sensitive data fields.

An optional embodiment of the present invention provides protection for a user while using messaging or communication services for example including but not limited to instant messenger (IM) so as to assist them in not providing sensitive information in an unprotected environment for example including but not limited to chartrooms, emails, ICQ, instant messengers, SMS or the like.

For example, during a messaging or chat session a user is persuaded to provide his sensitive login details for others through IM interface or browser. Optionally, the system and method of the present invention tracks the chat as it is being communicated to warn the user if he is about to deliver particular sensitive items of information and/or an overall amount of sensitive data that is greater than a permitted limit This parameter may optionally be set automatically or may be adjusted by the user.

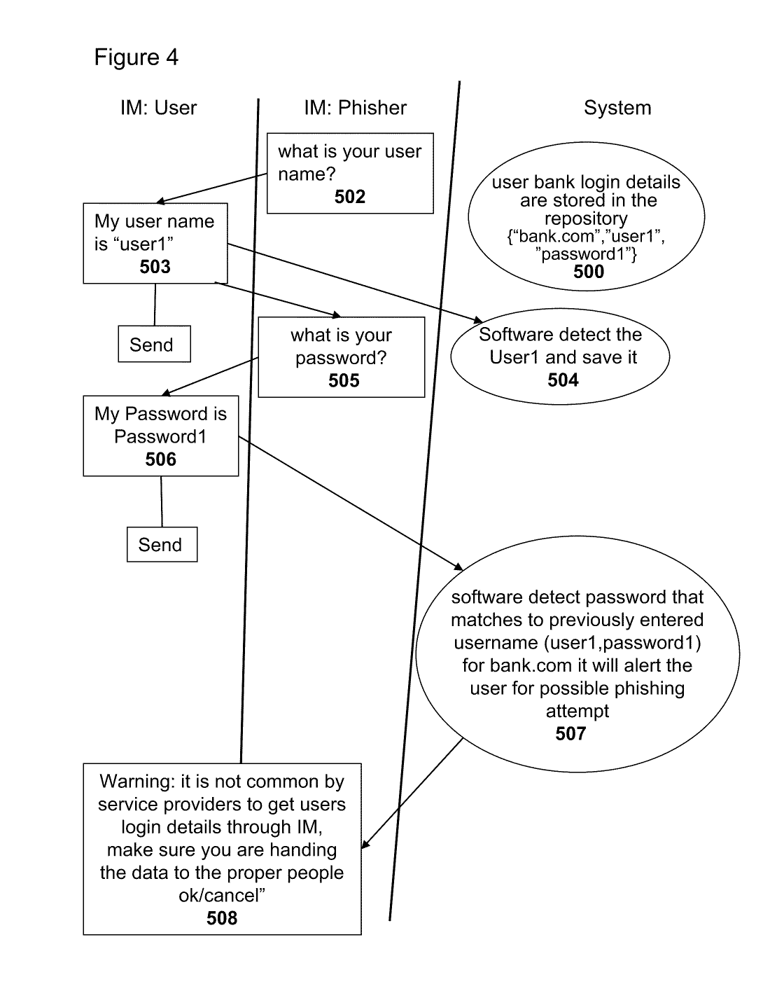

For example, as shown in FIG. 4, in stage 500 the user' s bank login details are stored in the repository (“bank.com”, “user1”, “password1”) based on an exemplary system as depicted in FIG. 1A-B. The following stages depict stages that may optionally occur during an chat or IM session between a user and phisher. In stage 502 the requests the sensitive information for example, Phisher: asks what is your user name? In stage 503, the user replies by sending the username, “user1”. In stage 504, the system according to the present invention preferably stores the detected occurrence where sensitive information was utilized based on the date stored in the repository according to the present invention, for example as depicted in stage 500. In stage 505, the suspected phisher requests further sensitive information for example asking for password. In stage 506, the user replies by at least attempting to send the password “password1”. In stage 507, the repository according to the present invention detects a match to the sensitive information entered in stage 503 for “bank.com”, preferably suspending or temporarily preventing data transmission of the sensitive information pending further user's input, directive or response to a triggered phishing alert issued in stage 508. Optionally, in stage 508, the alert may read “. . . it is not common by service providers to get users login details through IM, make sure you are handing the data to the proper people ok/cancel”. Preferably stages 507 and 508 are performed after the user tries to submit the sensitive data but before the sensitive data is actually sent. Most preferably, the system will continue to function based on the response of the user to the triggered warning as has been described previously in the application such as in FIG. 1A-B.

An exemplary method for customized email anti-phishing protection is described herein, preferably providing additional and optionally more sensitive or heightened anti-phishing protection specifically guarding against embedded links, optionally available through email, instant messages, SMS, chatrooms or the like link, or markup language links as is known and accepted in the art. Optionally, pages not reached directly from an embedded link may be allowed to pass. For example, typing a URL at the address field, click on home page, favorites and any subsequent embedded links will preferably not trigger the optional increased anti-phishing protection.

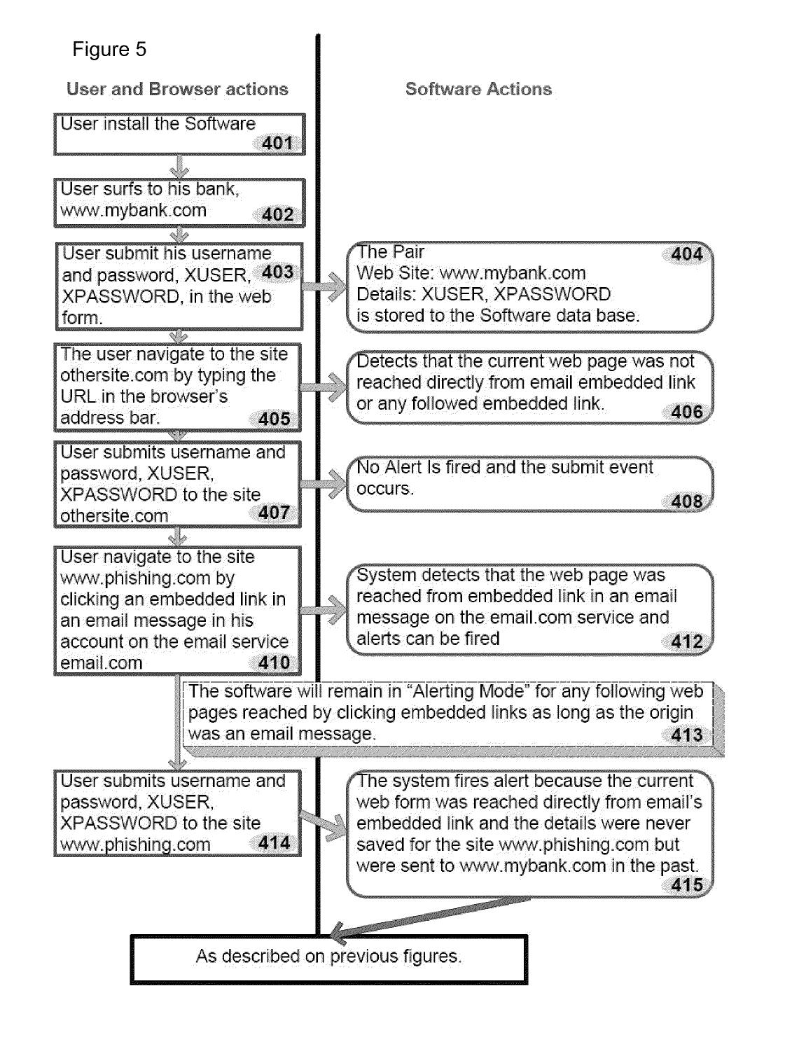

FIG. 5 depicts an exemplary scenario of the heightened anti-phishing protection provided by an optional embodiment of the present invention. Stages 401-404 depict the system and method according to a preferred embodiment as described in FIG. 1A where the user installs and uses the system and method according to the present invention. In stage 405 a user enters typing a URL at the address field of a web browser in an attempt to access the corresponding webpage. In stage 406 the system and method of the present invention check the origin of the webpage, optionally, to determine it originated in user entry in the address field of the web browser. Similarly, stages 407 and 408 depict a similar activity wherein user activity does not trigger an alert from the system and method of the present invention.

In stage 410, while a user opens a message in his email account at “www.email.com” comprising an embedded link and clicks or otherwise activates the embedded link to access a website “www.phishing.com”. In stage 412 the system and method according to an optional embodiment of the present invention detects that “www.phishing.com” was reached via an embedded link within an email. Preferably and optionally, stage 412 does not trigger a warning; rather it activates stage 413 wherein the system and method according to an optional embodiment of the present invention is to be on the heightened alert mode for phishing attempts for any web pages reached. Optionally, all pages that are accessed or reached by clicking on email embedded links or any internal embedded links, or any subsequent links, child links, are preferably individually categorized as “directed from email” and will preferably be checked by the heightened protection system and method of the present invention. In stage 414, optionally the user submits sensitive information, optionally in the form of username and password, on the new opened page “www.phishing.com” then the data will optionally and preferably trigger an alert, in stage 415, as the page originated with an embedded link and therefore optionally marked “direct from email”. Preferably, the system will continue to function according to an optional embodiment of the present invention as described in FIGS. 1A-B, most preferably to detect and prevent phishing attempts.

An email customized system and method according to the present invention optionally and preferably comprises system specific and specialized plug-ins customized for any email client for example including but not limited to Microsoft™ Outlook™, Thunderbird, or the like. Most preferably, an email customized system according to this optional embodiment optionally produces fewer alerts, preferably providing a security advantage for the email service provider.

A further optional embodiment of the present invention further comprises an Instant Messaging (IM) plugin for any IM application providing a user with anti-phishing protection that may arise from communication through web based communication via an IM application or chat for example including but not limited to ICQ™, Skype™, VoIP applications, Instant Messenger™, Net Meeting™, or the like application or platform.

An optional embodiment according to the present invention further comprises a central repository that is specifically associated with an email service provider and their specific platform. Optionally, a plurality of central repository may be associated with the individual email service providers made available to their users within the context of their email service and optional instant messaging (IM) communication or other web based communication during a web activity session related to their login to the email service.

Optionally, when a user is logged in to its email service, the local system will work with the specific user repository, whether local or preferably remote repository. The use of a remote repository can allow a plurality of users to use the same computer; the system protects and collects data for each user separately It can also allow the users to obtain protection on any computer used.

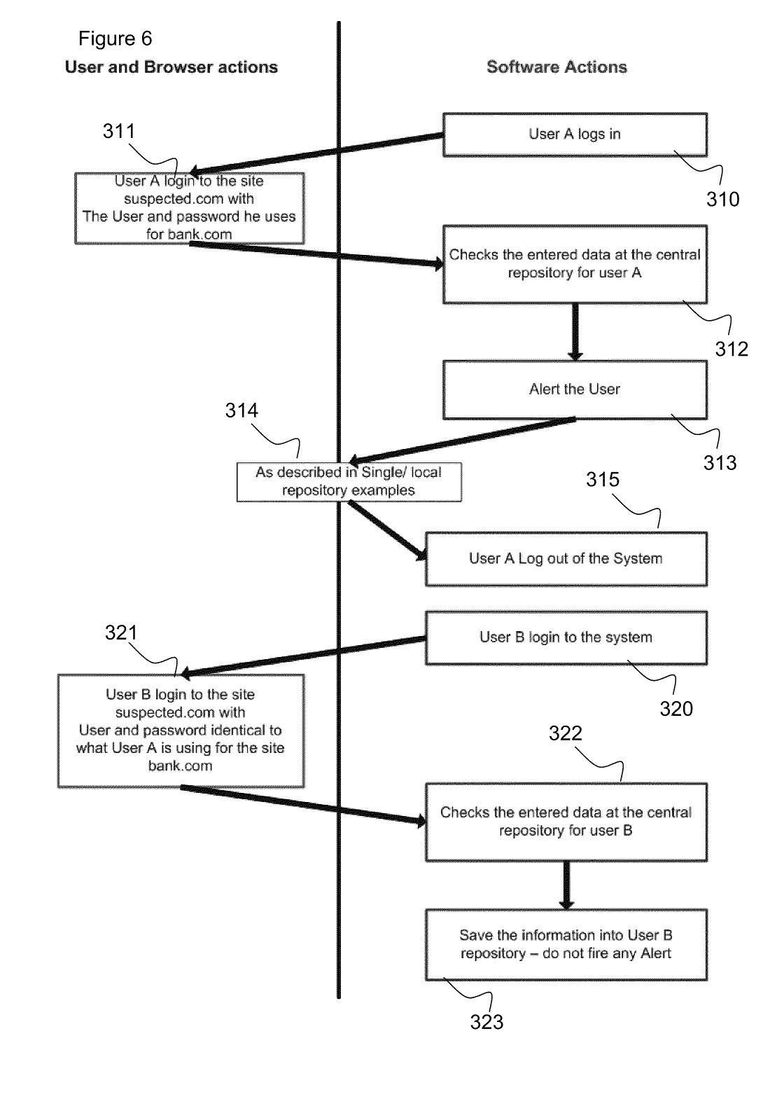

FIG. 6 depicts a further example of an implementation and use of a central repository with a plurality of users, for example that central repository 228 of FIG. 2B. FIG. 6 shows how a central repository functions to individually protect a plurality of users in the same manner as described in FIG. 1A-B against phishing attempts in the same manner as when using a personal computer 202 of FIG. 2A or a Public Computer 222 of FIG. 2B. Optionally, user A and user B may individually access the central repository 228 using the same computer, for example computer 202 or the same public computer 222 at different times. A central repository provides a plurality of users the option of remotely logging into a central repository, preferably comprising a plurality of accounts specifically associated with a plurality of users. Most preferably, the central repository may be implemented through a network connection for example including but not limited to an internet connection or an intranet connection. Preferably, a central repository enables a plurality of users to simultaneously gain access to their own personal repository within the centralized repository. Most preferably, the centralized repository configuration provides a user with the same protection as the user would benefit from if the repository was installed directly on a local computer, with an added value of remote access over a network connections optionally and preferably using means for use authentication as is known and accepted in the art for example including but not limited to username, password, Captcha, biometric identifies, or the like.

For example, in stage 310 User A logs into the central repository according to an optional embodiment of the present invention, preferably gaining access to User A's private repository within the central repository. A parallel process for a second user, User B, is depicted in stages 320 to 323. In stage 320 User B logs into the central repository, gaining access to his private repository within the central repository. Most preferably, the use of the central repository by User B and/or User A, is respectively independent of one another allowing both to use the system simultaneously, sequentially or in any manner or order, the sequential order depicted in the present example is for example purposes only and is a non-limiting example.

In stage 311 User A attempts to access a web site “www.suspected.com” with user authentication data or sensitive information that for example happens to be the authentication data used by User A to gain access to his bank information at a site www.bank.com, for example. In stage 312 the central repository checks the repository data specific to User A. In stage 313 central repository identifies the potential threat and preferably proceeds to issue a warning, alerting User A to the potential threat or error in using username “userAbank” and password “userAbankpswrd”. In stage 314 the central repository functions as previously described in FIGS. 1A-B and depending on the actions of User A, optionally issuing a warning to User A, stopping the transmission, stopping the transmission temporarily, providing User A with optional mode of action, reporting the site or the like action as described earlier. In stage 315 User A ends the current session disconnecting from the central repository. Optionally protection by the software operates as long as the session is in effect.

In stage 320, a second user, User B, logs in to the central repository 228, as described in FIG. 2B to gain access to User B's personal repository account to protect User B's sensitive information from fraud or phishing attempts. Optionally, log in process of stage 320 is provided over a network connection for example including but not limited to an intranet or internet connection as is known and accepted in the art. In stage 321 user B attempts to log into a web site using the username “userAbank” and password “userAbankpswrd” as did User A in stage 311. The entered information will initiate the phishing check in stage 322 that is specific to User B and in keeping with the repository for User B. Since User B does not have a history of using username “userAbank” and password “userAbankpswrd” associated with User B's repository, in stage 323, the central repository will preferably not trigger a response and save new data as described in FIGS. 1A-B to the repository associated with User B within the central repository, according to an optional embodiment of the present invention.

An optional embodiment of the present invention provides for customization of the system and method according to the needs of particular servers, networks and/or websites. Most preferably, customization of the system and method of the present invention is preferably provided by controlling the optional variable of the system. For example customizable variable optionally include but is not limited to encryption formulas specific to a network or site and/or other types of specific protection provided. For example, a bank may optionally utilize a specific formula in its encryption, while an email server may customize the system to protect users from emails for example including but not limited to links originating in junk mail, fraudulent links or the like.

Customization may also optionally limit the number of protected domains/web sites/URLs. Optionally an organization such as a bank will need to pay in order to be included in such a list.

The system may not produce alerts and save information when it will detect a suspect usage. For example, a bank may only allow 3 failures before access to that user is blocked. On the other hand, if a hacker is able to gain access to the user's computer, whether directly or through malicious software, the hacker may attempt an unlimited number of tries of user name and password combinations, in an attempt to force an alert from the software according to the present invention. Should the alert be received, then the hacker knows that the information is sensitive.

Optionally, the various embodiment of the present invention presented in the instant invention may be provided to an end user in a plurality of formats, platforms, and may be outputted to at least one of a computer readable memory, a computer display device, a computer on a network or a user. For example, the method and system of the present invention may be distributed in at least one of the following methods: free software for the end user, to organizations that optionally form a partnership as a limited version (for example the free limited version will protect up to 10 domains that the user chooses, while the full version that costs money will protect all user activity). Other examples of limitations include limiting the number of websites and/or the number of days of access. Limited versions of the system and method of the present invention may optionally be limited with respect to various controllable parameters for example including but not limited to time (ie. one month trial version), a particular domain address, a predetermined number of protected domains, size of white list, markup language interface protected (browser protected), the type of available protection (ie. email, IM, domains) or the like controllable parameter.

Another non-limiting example of a distribution model occurs when an ISP provider buys a license for the system and provides it as a free service to all of its members, even as an unlimited version. In other non-limiting examples, an organization pays a fixed price or per user, as plug-in licenses for other systems, such as toolbars, anti-viruses or the like.

Optionally a partnership may provide higher level protection, such as protecting specific user identifiers according to the request of the organization as mentioned before, security certification which can be provided by the software owners/operators to the partner organizations, reports and statistics regarding phishing attempts, user behavior leading to phishing attempts, sites prone to phishing attempts and so forth. Optionally the level or extent of protection may be controllable based on at least one or more parameters. For example, controllable parameters may optionally include but are not limited to price, number of protected domains, type of service. Optionally, a combination of at least two or more parameters may be utilized to limit or otherwise control the protection level provided to a user. Optionally, end users may be provided with a limited free version of the software by a partner, wherein the limited free version is dependent on the price level paid by partner.

While the invention has been described with respect to a limited number of embodiments, it will be appreciated that many variations, modifications and other applications of the invention may be made.

1. A method for preventing fraudulent provision of a user's sensitive data to a network address through a markup language interface comprising:
Associating a user's sensitive data with a network address forming an information pair;
storing said information pair on computer readable media;
monitoring an entry wherein said sensitive data is to be submitted through a markup language interface to a network address;
if said sensitive data matches said information pair but said network address does not match said information pair, determining whether an action is to be taken.

2. The method of claim 1, further comprising:
registering said entry wherein at least one of said user's sensitive data is submitted to said network address through a network connection.

3. The method of claim 1, further comprising:
Alerting the user.

4. The method of claim 3, wherein said alerting further comprises one or more of:
Requesting permission of the user to continue submission;
Blocking said submission; or
Requesting permission of the user to add said network address for said submission to a permitted white list;
Or a combination thereof.

5. The method of claim 4, further comprising:
If the user approves submission, storing said network address and said sensitive information as an information pair.

6. The method of claim 5, further comprising:
Blocking said submission.

7. The method of claim 6 wherein said blocked network locations are added to a black list.

8. The method of claim 7, further comprising:
storing said network address and said sensitive information as an information pair.

9. The method of claim 8, wherein said storing of said information pair further comprises requesting user permission to store said information pair, such that said information pair is stored only with said user permission.

10. The method of claim 8, wherein said storing said information pair is performed automatically, without user intervention.

11. The method of claim 10, wherein said automatically storing said information pair further comprises filtering said sensitive data before said storing.

12. The method of claim 11, wherein the user sensitive data is stored in an encrypted format.

13. The method of claim 12, wherein said encrypted user data is stored on a local computer.

14. The method of claim 13, wherein said data is stored at a computer and/or any peripheral device or other electronic device of the user.

15. The method of claim 12, wherein said encrypted format is created according to one-way encryption.

16. The method of claim 15 wherein said markup language interface is chosen from the group consisting of web browser, web page, web forms, chat room, instant message and an email client.

17. The method of claim 16 wherein said sensitive information is chosen from the group consisting of username, password, identification number, passport number, driver's license, social security number, security code, insurance policy number, security question and security answer.

18. The method of claim 17 wherein said encrypted data is stored remotely.

19. The method of claim 18 wherein said remote data is accessible through a network connection.

20. The method of claim 19 wherein access to said network connection requires user authentication.

21-47. (canceled)
